(19) United States
(12) Patent Application Publication
(10) Pub. No.: US 2024/0151294 A1
(43) Pub. Date: May 9, 2024

(54) GEARBOX

(71) Applicant: SPINEA, S.R.O., Haniska (SK)

(72) Inventor: Ján DZVONIK, Presov (SK)

(21) Appl. No.: 18/278,759

(22) PCT Filed: Feb. 21, 2022
(86) PCT No.: PCT/EP2022/054279

§ 371 Date: Aug. 24, 2023

(30) Foreign Application Priority Data
Feb. 26, 2021 (EP) 21159552.5

(51) Int. Cl. F16H 1/32

(52) U.S. Cl. CPC F16H 1/32; F16H 2055/176

(57) ABSTRACT

A transmission is described, comprising
a hollow cylindrical base body (1) with a first internal gear (z1),
a ring with a second internal gear (z2) arranged rotatably about the cylinder axis (14) of the base body (1),
a central shaft (9) extending along and rotatable about the cylinder axis (14) and having an eccentric section (13), and
a wheel (11) rotatably mounted on the eccentric portion and first external gear (zs1) via which it meshes with the first internal gear (z1) of the base body (1) and a second external gear (zs2) via which it meshes with the second internal gear (z2) of the hollow cylindrical ring.

The wheel (11) is designed as a double wheel. The double wheel comprises two individual wheels which are non-rotatably connected to each other in accordance with their axes and are each provided with one of the two external gears (zs1, zs2). The single wheels are connected to each other by bonded connecting means. The connecting means are bonded to both one and the other individual wheel.

The invention relates to a gear unit designed as a cycloidal gear unit according to the generic term of claim 1. In particular, the invention relates to a precision gear unit which is used especially in robot technology.

Advantageous properties of cycloidal gearboxes, which are also occasionally referred to as trochoidal gearboxes, are known from gear theory:
high accuracy in backlash-free operation,
a high load capacity,
a low friction and
a high degree of efficiency.

These properties make cycloidal gear units particularly suitable for use in precision gear designs.

A cycloidal gearbox includes:
a hollow cylindrical base body
The base body is provided with internal gear. The internal gear is located on the inner circumference of the hollow cylindrical base body.
A central shaft
The central shaft is coaxial with the cylinder axis of the base body and rotatable relative to the base body. It is provided with an eccentric section.
a wheel with one external gear
The wheel with external gear is rotatable on the eccentric section and circumferentially arranged in the base body. The external gear meshes with the internal gear on the inner circumference of the hollow cylindrical base body.
an organ arranged coaxially to the cylinder axis
This organ is arranged rotatably with respect to the central shaft as well as rotatably with respect to the base body.

The element or the central shaft forms an input element of the cycloidal drive. The remaining element, i.e. the central shaft or the element, forms an output element of the cycloidal drive.

Furthermore, each cycloidal transmission has means for converting the rolling motion of the wheel in the main body into a rotational motion of the member about the cylinder axis.

The means for converting the rolling motion of the wheel in the basic body into a rotational motion of the organ about the cylinder axis comprise one or more transformation elements. These means are also referred to below as the transformation system. The rolling motion of the wheel in the basic body circulating at the internal gear is hereinafter referred to briefly as planetary motion. Accordingly, the planetary motion takes place as a rolling motion of the wheel in the basic body circulating on the internal gear. Because of its preferred design as an output element of the gear unit, the element is also referred to as an output flange.

JP 2020 122582 A describes a cycloidal gearbox. The planetary motion of the wheels is converted into the rotary motion of the output flange by means of eccentrically arranged eccentric shafts.

JP H01 169154 A is a known cycloidal gearbox. The conversion of the planetary motion of the wheels into the rotary motion of the output flange is performed by means of pins integrated in the output flange.

EP 2 255 104 A1 describes a cycloidal gear unit. The planetary motion of the wheels is converted into the rotary motion of the output flange by means of crosses arranged between the wheels and the output flange.

The gear used in these gear units is a cycloidal shape of the gear of the wheel rolling in the base body serving as the housing. The cycloidal shape of the gear is referred to below as cycloidal gear.

A gear unit is also known from US 2004/083850 A1. In this gear, the gear wheel rolling in the housing is provided with special gear.

The group of cycloidal gear units described above are special planetary gear units. In these, the wheels roll in the hollow-cylindrical base body. Their external teeth mesh with the internal teeth in the hollow-cylindrical base body. During this process, the wheels perform a planetary motion around the center axis of the gear unit. The center axis of the gear unit coincides with the cylinder axis of the base body.

Each of the transformation systems of these cycloidal gear units simultaneously transmits the power flow from the wheels to the output flange. The disadvantage is that this takes up a certain radial space in the wheels, which limits the achievable minimum dimensions of the gear units.

Also suitable for precision gear designs are planetary gearboxes.

A planetary gear suitable for precision gear designs is known by U.S. Pat. No. 10,352,400 B2. The advantage of this gear is the symmetrical counter-distribution of forces to the rigid wheels. This leads to a relatively high load capacity. A disadvantage of such a gear is that the radial space is occupied by the satellite wheels themselves.

In addition, other gear units are known for use in precision gear designs. These operate on a principle also known as deformation shaft transmission. These gears include a radially deformable element, which is called a flexspline or also a flex-spline. A specially shaped external spline is formed on the flexspline. Radial deformation of the flexspline causes the external spline to engage with an internal spline. The internal teeth are formed in a rigid counterpart. The rigid counterpart is known as a circular spline or circular spline. The principle used makes it possible to manufacture small gears and gears with a central through-opening. Such a central through-opening is also referred to below as a hollow shaft or a central hollow shaft opening.

Such a gearbox is manufactured, for example, by the company HARMONIC DRIVE SYSTEMS.

However, the flexibility of the deformable element in the gear limits the value of stiffness and load capacity. For small gears with a decrease in the diameter of the flexspline, the gear module also decreases. This limits both the load capacity and the maximum achievable value of the transmission ratio.

JP 2014 035030 A discloses a cycloidal transmission with a two-stage wheel. The cycloidal gear has a housing in which a drive shaft is rotatably mounted. The wheel is rotatably arranged on an eccentric section of the drive shaft. It has external teeth. By means of the external gear, the wheel meshes with an internal gear of the housing. The wheel also has an internal gear. Via the internal gear, the wheel meshes with an external gear of an output shaft. The gear is designed free of needle rollers. Instead, it comprises cycloidal teeth of its meshing teeth. The cycloidal gear is in the form of a modified cycloid. A disadvantage of this is that the use of internal teeth in the wheel takes up radial space. In addition, the bearing of the input shaft in the output shaft also occupies radial space. Both of these factors limit the formation of small gears with a central hollow shaft opening.

A gear unit is known from BE 495812, U.S. Pat. No. 4,584,904 and DE 195 42 024 A1. The gearbox comprises a hollow-cylindrical base body that has a first set of internal teeth. The gear also comprises a ring. This is provided with a second internal gear. The ring is arranged to rotate about the cylinder axis of the base body. The transmission further comprises a central shaft. The central shaft extends along the cylinder axis. The central shaft is rotatably disposed about the cylinder axis and includes an eccentric portion.

The transmission further comprises a wheel. The wheel is rotatably disposed on the eccentric portion and has first external teeth. The wheel meshes with the first external teeth with the first internal teeth of the hollow cylindrical base body. It has a second external gear. The wheel meshes with the second external gear with the second internal gear of the ring. The wheel is configured as a double wheel. The double wheel comprises two sprockets non-rotatably connected to each other in correspondence of their axes. Each gear rim is provided with one of the two external gears. The external teeth are formed by trochoidal surfaces. The trochoidal surface of the first external gear has a different number of teeth than the trochoidal surface of the second external gear. The term number of teeth here is representative of the number of elevations separated by intervening depressions. The elevations and depressions are formed by the trochoidal surface. The trochoidal surface is modeled on a cycloidal path.

The previously known gear units do not have a central hollow shaft opening.

DE 11 2017 000 935 T5 also discloses a gear unit. This gearbox comprises a hollow-cylindrical base body. The base body has a first internal gear. The transmission also comprises a ring provided with a second internal gear. The ring is arranged to rotate about the cylinder axis of the base body. The transmission further comprises a central shaft. The central shaft extends along the cylinder axis. It is arranged rotatably about the cylinder axis. The central shaft has an eccentric section. The transmission further comprises a wheel rotatably disposed on the eccentric portion. The wheel has first external teeth. The wheel meshes with the first external teeth with the first internal teeth of the hollow cylindrical base body. The wheel has a second external gear and meshes therewith with the second internal gear of the ring. The wheel is configured as a double wheel. The double wheel comprises two individual wheels non-rotatably connected to each other in correspondence of their axes. Each individual wheel is provided with one of the two external gears. The external gear is a cycloid structure. Each individual wheel is therefore designed as a cycloidal disk. At least one pin connects the two individual wheels. The term pin is used here to refer to a pin, a screw or a combination thereof. The pin is inserted in axial fastening bores in the individual wheels. The axial fastening holes in the individual gears are opposite each other. The axial fastening bores are designed as off-center through bores. As an alternative to connecting the individual wheels by means of a pin to form a double wheel, the following is provided:
to glue the individual wheels to each other on the front side or
to produce the double wheel as an integral structure.

A disadvantage of this gear unit is that when pins are used, the axial mounting holes in the two individual gears must be produced coaxially with high accuracy. This is the only way to achieve a high load capacity of the gear unit. A high load capacity requires a high accuracy of the gear unit. The high accuracy must also be ensured at the bearing tracks on the two individual gears. Deviations of the two individual gears from the common axis of rotation about the eccentric section stand in the way of high accuracy and high load capacity. Producing the axial mounting holes coaxially in both individual gears with high accuracy is a very demanding operation. The required accuracy is in the range of a few micrometers. This increases the production costs considerably.

Another disadvantage is that the pins must be pressed into the individual wheels with an overlap in order to be axially secured against ejection. If the pins are ejected from the wheels during operation, the gearbox will be damaged or completely destroyed. But even a small overlap between the pins and the mounting holes in the wheels causes deformation of the wheels. This leads to a decrease in the achieved accuracy of the gearbox. This results in high motion losses and high angular transmission errors.

One task of the invention is to create a cycloidal gear unit with the smallest possible installation space requirement and the greatest possible load capacity. The cycloidal gear unit should also be able to have a central hollow shaft opening. It should also be cost-effective to manufacture. Finally, it should have high precision.

The task is solved by the features of the independent claim. Advantageous embodiments are reproduced in the claims, the drawings and in the following description, including those pertaining to the drawings.

Accordingly, an object of the invention relates to a transmission also referred to as a cycloidal transmission. The gearbox is provided with a hollow-cylindrical base body also briefly referred to as a body. The body is provided with a first internal gear. The transmission includes a ring that is also hollow cylindrical in shape. The ring is provided with a second internal gear. The ring is rotatably arranged on the base body. The cylinder axes of the hollow-cylindrical base body and the hollow-cylindrical ring coincide with each other. The ring is arranged on the base body so as to be rotatable about the cylinder axis.

The ring can be rotatably mounted as an inner ring in the base body. Alternatively, the base body and the ring can be rotatably connected to each other axially adjacent.

An axial separating ring can be arranged between the ring designed as an inner ring and the base body.

A bearing can be arranged between the base body and the ring, which is designed as an inner ring, for example. For example, the bearing can rotatably connect the base body and the inner ring.

One or both internal splines can comprise needle rollers, for example. The needle rollers can be inserted in internal grooves. Such internal grooves for the needle rollers can be worked into the inner circumference of the base body. Alternatively or additionally, such inner grooves for the needle rollers can be worked into the inner circumference of the ring. The ring can be designed as an inner ring, for example.

In addition, the cycloidal transmission includes a central shaft with an eccentric section. The central shaft extends along the cylinder axis. It is arranged so that it can rotate about the cylinder axis relative to the main body.

It is important to emphasize in this context that in the present document the term axis, in contrast to the term shaft, denotes a geometric axis and not a machine element.

The central shaft can be rotatably mounted at its two spaced ends once on the base body and once on the ring. The ring can in turn be designed as an inner ring.

For example, a cover can be connected to the base body, and the central shaft can be rotatably mounted on or in the cover. The cover can be firmly and therefore non-rotatably connected to the base body.

Alternatively or additionally, a cover can be connected to the ring. The central shaft is rotatably mounted on or in the cover. The ring can again be designed as an inner ring, for example.

The cover may be firmly connected to the ring. According to this, the cover is nonrotatably connected to the ring. The ring can be designed as an inner ring, for example.

In particular, bearings can be provided to protect the central shaft from
the base body and/or
the ring designed as an inner ring, for example, and/or
the cover which is non-rotatably connected to the base body and/or
the cover, which is non-rotatably connected to the ring, which is designed, for example, as an inner ring
   to be arranged rotatably.

It is also conceivable to have an alternative or additional rotatable bearing arrangement of the cover relative to the base body and/or of the cover relative to the ring, which is designed as an inner ring, for example.

Further, the cycloidal transmission comprises a wheel rotatably disposed on the eccentric portion of the central shaft. The wheel is provided with a first external gear. It meshes via the first external gear with the first internal gear of the hollow cylindrical base body. Furthermore, the wheel is provided with a second external gear. It meshes via the second external gear with the second internal gear of the likewise hollow-cylindrical ring.

The wheel is designed as a double wheel. The double wheel consists of two individual wheels that are connected to each other so that they cannot rotate. The axles of the individual wheels coincide with each other. The two individual wheels are each provided with external gear.

In other words: If the wheel is designed as a double wheel, it consists of two individual wheels connected to each other in a non-rotatable manner in accordance with their axes and each provided with external teeth.

The dual wheel is formed by bonding two separate individual wheels. The two individual wheels are connected to each other by bonded connecting means. The glued connecting means also serve to ensure their exact axial alignment in accordance with their axes.

Thus, the transmission is characterized by the fact that the two individual wheels are each connected by at least one connecting means bonded to both one and the other individual wheel.

According to this, a connecting means is bonded to the one individual wheel at a suitable point. The lanyard is also bonded to the other individual wheel at a suitable point.

The suitable points at which the connecting means is bonded to the two individual wheels in each case advantageously allow clearance between the two individual wheels in the unglued state both with regard to the axle position and with regard to the rotational position of the two individual wheels about their axles. In this way, tolerance compensation is created by bonding to both the one and the other individual wheel. This permits simple and cost-effective manufacture of the individual wheels. For example, two individual wheels can be produced within predefinable tolerance limits. A first of the two individual wheels is inserted into a jig. The connecting means is then arranged on the first individual wheel. An adhesive can now be applied to produce the bond between the first single wheel and the connecting means and between the connecting means and the remaining single wheel. As long as the adhesive has not yet cured, the second individual wheel is aligned with a precise fit by means of the gauge and arranged on the first individual wheel. After the adhesive has cured, the two individual wheels are precisely aligned with each other. For example, a connecting means is glued into a suitable first recess in the one individual wheel. In addition, the connecting means is glued into a suitable second recess in the other individual wheel.

The connecting means may be bonded pin connections. For example, the two individual wheels can be connected to each other and axially secured by bonded pin connections.

The bonded pin connections can extend through axial through holes in a first of the two single wheels into axial blind holes in the remaining single wheel of the two single wheels. The pin connections are bonded both in the through holes to the first single wheel and in the blind holes to the remaining single wheel.

Alternatively or additionally, the bonded pin connections can be arranged and bonded in blind holes arranged opposite each other on the faces of the individual wheels.

If multiple pin connections are provided, one part may be glued into through holes in one individual wheel and into blind holes in the other individual wheel, as previously described. A remaining part of the pin connections can be glued into blind holes in both individual wheels.

Alternatively or additionally, the two individual wheels can be axially secured by at least one bonded ring. The two individual wheels can also be bonded directly to each other.

By bonding each of the two individual wheels with a connecting means bonded to both individual wheels, a cost-effective and simple production of the wheel designed as a double wheel is created. The double wheel is designed with the highest precision. The double wheel carries the first and the second external gear and is formed by two separately manufactured individual wheels. The connecting means are used to connect the individual wheels to each other with the highest precision and yet at low cost to form the double wheel. The connecting means can be bonded to both the one and the other individual wheel while compensating for a tolerance with respect to axial and rotational position. If, for example, a jig is used when bonding the individual wheels to the connecting means to form the double wheel, manufacturing tolerances of the external gears and bearing rings of the individual wheels can be compensated for.

It can be seen that the invention can be realized by a cycloidal gearbox with a central shaft. The central shaft is supported at both ends thereof. The central shaft has an eccentric section. A radial bearing may be arranged on the eccentric section. A double wheel is arranged on the radial bearing. The double wheel has two external teeth in cycloidal form. It is formed by bonding two individual wheels together. The individual wheels are axially secured against each other by connecting means, such as bonded pins or a bonded ring. The connecting means simultaneously transmit part of the torque between the two wheels. The diameters of the tip circles and the root or heel circles of the external gears are the same on both individual gears, while the number of teeth varies.

An advantageous further development of the gear provides that the diameters of the tip circles and the diameters of the root circles, sometimes also referred to as heel circles, of the two external gear teeth on the wheel are the same. In this case, the number of teeth is different.

Advantageously, the gear has cycloidal teeth at least for the first external teeth and the second external teeth.

The internal splines may include needle rollers located in internal grooves recessed on the inner circumference of the base body and ring.

The needle rollers arranged in the inner grooves of the body and of the ring, which is preferably designed as an inner ring, are preferably secured axially and radially in the recesses of the covers and.

The central shaft is advantageously hollow. It can be designed as a hollow shaft or with a central through-opening, also known as a hollow shaft opening.

It is important to emphasize that the invention may be realized by a gear having cycloidal teeth:
with a body and an inner ring, between which an axial separating ring is arranged and
with a bearing that rotatably connects the body and the inner ring.
The internal splines include needle rollers and internal grooves for the needle rollers, which mesh with cycloidal external splines of the wheel designed as a double wheel.
The wheel is located on an eccentric section formed on the shaft, briefly referred to as the eccentric surface.
The shaft is located at both ends of the bearings in the covers.
The covers are firmly connected to the body or inner ring.

The gear is characterized, for example, by the fact that the diameters of the tip circles and the diameters of the root circles, sometimes also called heel circles, of the two cycloidal gears on the wheel designed as a double wheel are the same. At the same time, the number of teeth is different.

The transmission may alternatively or additionally have individual or a combination of several features described introductory in connection with the prior art and/or in one or more of the documents mentioned regarding the prior art and/or in the preceding and/or subsequent description regarding the embodiments shown in the drawings.

Additional advantages over the state of the art that go beyond the complete solution of the set task and/or beyond the advantages mentioned above for the individual features are listed below.

The invention creates a precision gear with cycloidal teeth, the use of which is particularly in robotics technology. In particular, the invention is industrially applicable where precision gears with small dimensions, with low weight and with relatively large opening in the shaft are required.

The invention reduces radial space constraints in cycloidal gears by not using transformation elements between the gears and the outlet flange. This meets the requirements for precision gears with small dimensions, low weight and a relatively large central through hole in the shaft.

Accordingly, the invention enables cycloidal gear unit designs with small dimensions and with a hollow shaft or a central through-opening also known as a hollow shaft opening.

In addition, it is possible to achieve a much wider range and maximum value of transmission ratios with a relatively high load capacity and low manufacturing costs.

The invention is explained in more detail below with reference to examples of embodiments shown in the drawing. The proportions of the individual elements in relation to one another in the figures do not always correspond to the actual proportions. Some shapes are simplified and other shapes are shown enlarged in relation to other elements for better illustration. Identical reference signs are used for elements of the invention which are identical or have the same effect. Further, for the sake of clarity, only reference signs necessary to describe the particular figure are shown in the individual figures. The embodiments shown are merely examples of how the invention can be designed and do not represent a conclusive limitation. It shows in schematic representation:

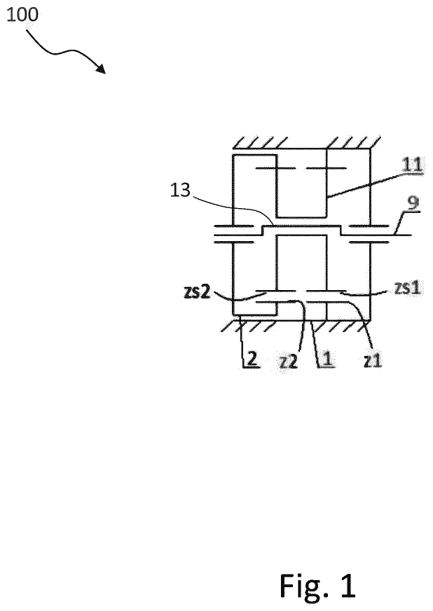

FIG. 1a kinematic diagram according to a first embodiment of a transmission designed as a cycloidal transmission,

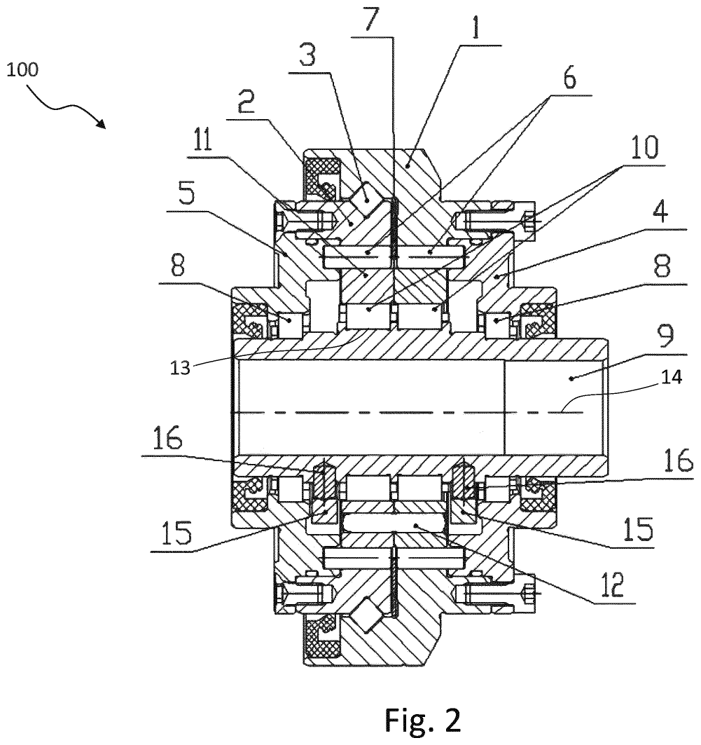

FIG. 2 An example of a transmission designed as a cycloidal transmission according to the kinematic diagram in FIG. 1 in a longitudinal section through the transmission running along the cylinder axis,

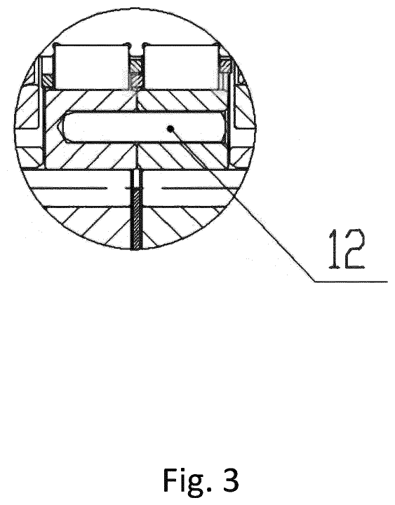

FIG. 3a first embodiment of a double wheel in a detailed view in a longitudinal section. Two individual wheels are connected to each other by bonded connecting means to form the double wheel. In this embodiment, the connecting means comprise bonded pin connections. The single wheels are connected to each other by means of glued pin connections to form the double wheel. The bonded pin connections are bonded into axial blind holes in one of the two single wheels. On the remaining single wheel, through-holes are arranged opposite the blind holes, into which the pin connections are also glued. The glued pin connections extend through the axial through-holes in one of the two single wheels into the axial blind holes in the remaining single wheel,

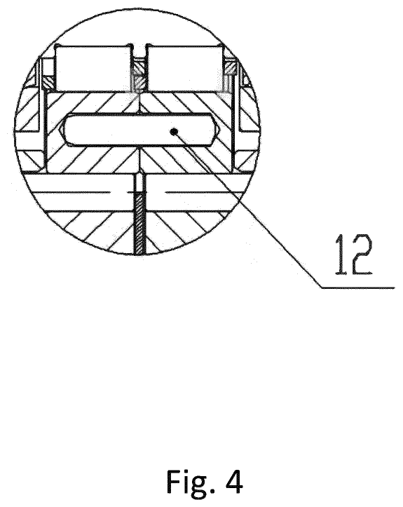

FIG. 4a second embodiment of a double wheel in a detailed view in a longitudinal section. Two individual wheels are connected to each other by bonded connecting means to form the double wheel. In this embodiment example, the connecting means comprise bonded pin connections. The single wheels are connected to each other by means of bonded pin connections to form the double wheel. Blind holes are arranged opposite each other on both single wheels. The glued pin connections are glued into the opposing blind holes on both sides. The bonded pin connections extend from one axial blind hole in one of the two single wheels into the opposite axial blind hole in the remaining single wheel,

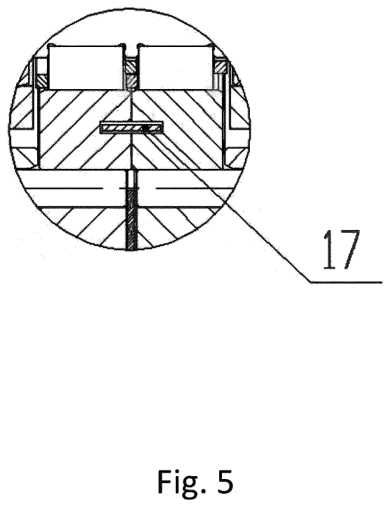

FIG. 5a third embodiment of a double wheel in a detailed view in a longitudinal section. Two individual wheels are connected to each other by bonded connecting means to form the double wheel. In this embodiment, the connecting means comprise a bonded ring. The individual wheels are connected to each other by means of the bonded ring to form the double wheel. Ring-shaped grooves are let in opposite each other on both single wheels. The glued ring is glued into the opposing annular grooves on both sides. The annular grooves are also known as groove rings or ring grooves. The glued ring extends from the groove ring in one of the two individual wheels into the opposite groove ring in the remaining individual wheel,

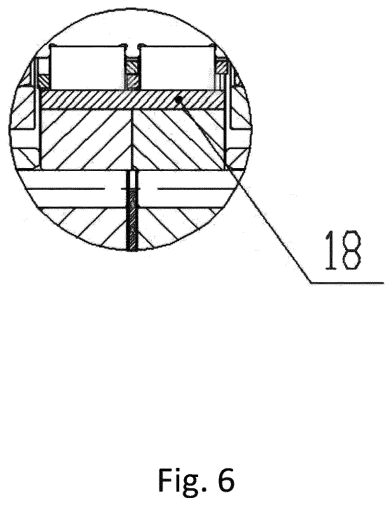

FIG. 6a fourth embodiment of a double wheel in a detailed view in a longitudinal section. Two individual wheels are connected to each other by bonded connecting means to form the double wheel. In this embodiment, the connecting means comprise a bonded ring. The individual wheels are connected to each other by means of the bonded ring to form the double wheel. The ring is bonded to the inner surfaces of the two single wheels facing away from the outer teeth. The glued ring is glued to the inner surfaces on both sides. The bonded ring extends over the entire double wheel from the outer edge of the inner surface of one single wheel facing away from the contact surface between the two single wheels to the outer edge of the inner surface of the remaining single wheel,

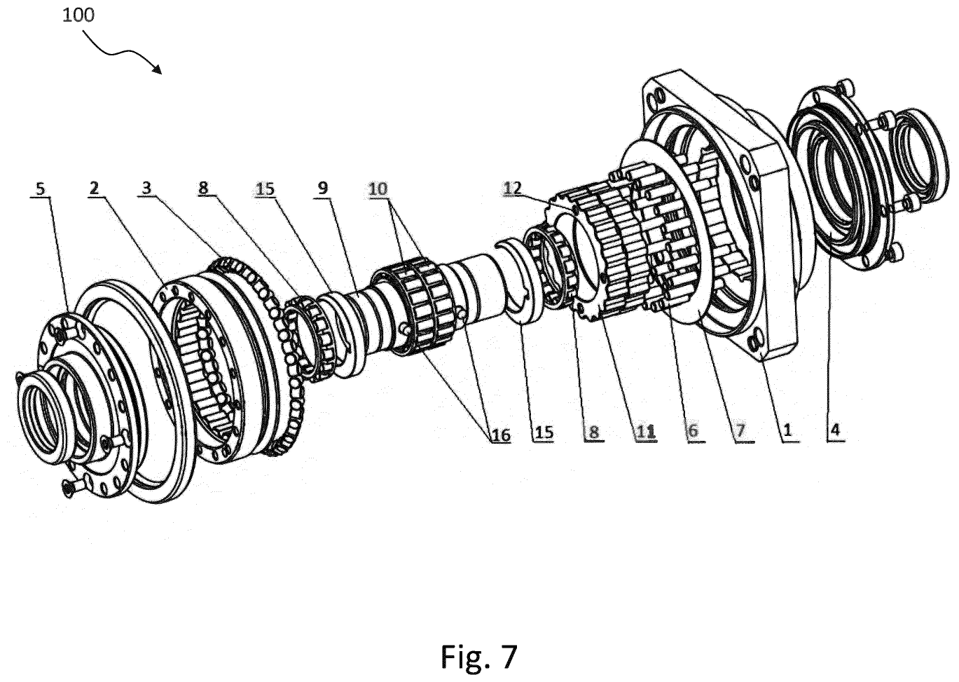

FIG. 7 an exploded view of the cycloidal gear unit of FIG. 2 in an axonometric view.

A transmission shown in FIG. 1, FIG. 2, FIG. 3, FIG. 4, FIG. 5, FIG. 6, and FIG. 7, in whole or in part, formed as a cycloidal transmission 100 comprises:
a hollow cylindrical base body 1. The base body 1 is also referred to as the body for short. The base body 1 is provided with a first internal gear z1.
a central shaft 9. The central shaft 9 extends along the cylinder axis 14 of the base body 1. The central shaft 9 is arranged coaxially to the cylinder axis 14 of the base body 1. The central shaft 9 is arranged rotatably relative to the base body 1. The central shaft 9 is provided with an eccentric section 13.
a wheel 11 rotatably arranged on the eccentric section 13. The wheel 11 rotates in the base body 1. The wheel 11 is provided with a first external gear zs1. The first external gear zs1 meshes with the first internal gear z1 on the inner circumference of the hollow cylindrical base body 1.
a ring arranged coaxially to the cylinder axis 14. The ring is arranged both rotatably relative to the central shaft 9 and rotatably relative to the base body 1.

As already mentioned, in the present document the term axis, in contrast to the term shaft, denotes a geometrical axis and not a machine element.

In the case of the transmission designed as a cycloidal transmission 100:
the hollow cylindrical ring is provided with a second internal gear z2. The ring is rotatably arranged in or on the base body 1 in correspondence of its cylinder axis with the cylinder axis 14 of the hollow-cylindrical base body 1,
the wheel 11 is rotatably arranged on the eccentric section 13 of the central shaft 9,
the wheel 11 is provided with the first external gear zs1. The first external gear zs1 of the wheel 11 meshes with the first internal gear z1 of the base body 1,
the wheel 11 is provided with a second external gear zs2. The second external gear zs2 of the wheel 11 meshes with the second internal gear z2 of the hollow cylindrical ring.

These measures make it possible to create a transmission designed as a cycloidal transmission 100 with both the smallest possible installation space requirement and the greatest possible load capacity. Such a transmission can additionally be designed free of means for converting the rolling motion of the wheel 11 in the basic body 1 into a rotational motion of an organ. In the cycloidal transmission 100, the organ is the ring. The ring is mounted on the base body 1 so as to be rotatable about the cylinder axis 14. A separate transformation system is therefore not required.

Advantageously, the diameters of the tip circles and the diameters of the root circles, sometimes also referred to as heel circles, of the two external gears zs1, zs2 on wheel 11 are the same. At the same time, the number of teeth is different. This achieves an increase in the load capacity of the gear created with maximum utilization of the available installation space.

Advantageously, the central shaft 9 is hollow. This creates a gear unit designed as a heavy-duty cycloidal gear unit 100. The gear unit is suitable for precision gear unit designs. In addition to the advantages described above and below, the gear unit has a central hollow shaft opening.

Preferably, the ring is designed as an inner ring 2 rotatably mounted in the base body 1. Alternatively, the base body 1 and the ring can be rotatably connected to each other axially adjacent.

Advantageously, an axial separating ring 7 can be arranged between the ring, which is preferably designed as an inner ring 2, and the base body 1.

A further development of a gear unit 100 preferably designed as a cycloidal gear unit provides that one or both internal gears z1, z2 comprise needle rollers 6. Accordingly, the first internal gearing z1 and/or the second internal gearing zs2 preferably comprise needle rollers 6. For example, a cover 4 can be connected to the main body 1. The central shaft 9 can be rotatably mounted in the cover 4.

The cover 4 can be firmly and thus non-rotatably connected to the base body 1. Accordingly, the lid 4 can be non-rotatably connected to the base body 1.

Alternatively or additionally, a cover 5 can be connected to the ring designed, for example, as an inner ring 2. The cover 5 can be firmly connected to the ring, which is designed as an inner ring 2, for example.

If the internal splines z1, z2 comprise needle rollers 6 which are advantageously inserted in internal grooves let into the inner circumference of the basic body 1 and of the ring, the needle rollers 6 arranged in the internal grooves of the body 1 and in the internal grooves of the ring 2, which is preferably designed as an inner ring, are preferably secured axially and radially in recesses of the covers 4 and 5 provided specifically for this purpose (FIG. 2).

A bearing 3, preferably designed as a rolling bearing, can be arranged between the base body 1 and the ring designed, for example, as an inner ring 2. For example, the bearing 3 can rotatably connect the base body 1 and the inner ring 2 (FIG. 2).

The central shaft 9 can be rotatably mounted at its two spaced ends once on the base body 1 and once on the ring designed, for example, as an inner ring 2.

In particular, bearings 8 may be provided to support the central shaft 9 opposite:
the base body 1 and/or
the ring designed, for example, as an inner ring 2 and/or
the cover 4 which is non-rotatably connected to the base body 1 and/or
the cover 5, which is non-rotatably connected to the ring, which is designed, for example, as an inner ring 2
   to be arranged rotatably.

Furthermore, an alternative or additional rotatable mounting of the cover 4 relative to the base body 1 and/or of the cover 5 relative to the ring designed, for example, as an inner ring 2 is conceivable.

A particularly advantageous embodiment of the gear unit in the light of simple production of the first external gear zs1 and the second external gear zs2 on the wheel 11 is that the wheel 11 is designed as a double wheel.

The dual wheel comprises two individual wheels which are non-rotatably connected to each other in accordance with their axes. The individual wheels are each provided with one of the two external gears zs1, zs2. This simplifies the manufacture of the two adjacent external gears zs1 and zs2.

The wheel 11, which is designed as a double wheel, is advantageously formed by bonding two individual wheels.

The two individual wheels are particularly advantageously connected by bonded connecting means. The bonded connecting means are bonded to both the one and the other individual wheel. The bonding is carried out in each case with the aid of bonded connecting means.

The connecting means may comprise bonded pin connections 12. Advantageously, the single wheels bonded together may be axially secured by bonded pin connections 12. As shown in FIG. 3, the bonded pin connections 12 may extend through axial through-holes in one of the two individual wheels into axial blind holes in the remaining individual wheel of the two individual wheels.

In a double wheel partially shown in FIG. 3, two individual wheels are connected to each other by bonded connecting means to form the double wheel. The connecting means comprise bonded pin connections 12. Axial blind holes are arranged in one of the two single wheels. The bonded pin connections 12 are bonded into the axial blind holes, one bonded pin connection 12 per blind hole. Through holes are arranged on the remaining single wheel opposite the blind holes in the first single wheel. The pin connections 12 are also glued into the through holes, again one glued pin connection 12 per through hole. The glued pin connections 12 extend through the axial through holes in one of the two single wheels into the axial blind holes in the remaining single wheel.

The bonded pin connections 12 can alternatively or additionally be arranged in blind holes arranged opposite each other on the faces of the individual wheels, as shown in FIG. 4.

In a double wheel partially shown in FIG. 4, two individual wheels are connected to each other by bonded connecting means to form the double wheel. The connecting means comprise bonded pin connections 12. Axial blind holes are arranged opposite one another in both of the two single wheels. The glued pin connections 12 are glued into the axial blind holes, one glued pin connection 12 in each of the opposing pairs of blind holes on the facing end faces of the single wheels. The glued pin connections 12 extend from an axial blind hole in one of the two single wheels into the opposing axial blind hole in the remaining single wheel.

The pin connections 12 advantageously have a diameter D. The blind holes or through holes advantageously have a diameter D+Δ.

Advantageously, the pin connections 12 with diameter D are glued into blind holes and/or through holes with diameter D+Δ in the individual wheels.

The wheel 11, which is designed as a double wheel, is created by bonding two separate individual wheels. The individual wheels are secured axially by bonded pin connections 12. FIG. 2, FIG. 3 and FIG. 4 show three different designs of bonded pin connections 12 for connecting two individual wheels. The pins 12 with diameter D are glued in the holes of diameter D+Δ in the single wheels. Δ is representative of an inaccuracy that occurs during manufacturing and heat treatment. The uncertainty value Δ is eliminated in the adhesive layer in the contact surfaces of the joint.

According to this, the wheel designed as a double wheel is formed, for example, by bonding two individual wheels that are axially secured by bonded pin connections 12. The connecting means may comprise a bonded ring 17, as shown in FIG. 5. The two individual wheels are axially secured by such a ring 17. The ring 17 is glued into annular grooves arranged opposite each other on the faces of the individual wheels. The grooves run annularly around the common axis of the individual wheels. The annular grooves are also referred to as groove rings or ring grooves.

In a double wheel partially shown in FIG. 5, two individual wheels are connected to each other by bonded connecting means to form the double wheel. The connecting means comprise the bonded ring 17. Ring grooves are recessed in the facing end faces of both individual wheels. The ring grooves are arranged opposite each other. The bonded ring 17 is bonded into the opposing ring grooves on both sides. The glued ring extends from the ring groove in one of the two individual wheels into the opposite ring groove in the remaining individual wheel.

The wheels can then be axially connected to the bonded ring 17 and secured. The structure of this connection of two individual wheels is shown in FIG. 5. The ring 17 of thickness H is glued into the ring groove of width H+Δ on both individual wheels. Δ is an inaccuracy that arises during manufacturing and heat treatment. The uncertainty value Δ is eliminated in the adhesive layer in the contact surfaces of the joint.

Instead of the rings 17, the lanyards can also be connected to the rings 18, as shown in FIG. 6.

In a double wheel partially shown in FIG. 6, two single wheels are connected to each other by bonded connecting means to form the double wheel. The connecting means comprise the bonded ring 18. The ring 18 is bonded to the inner surfaces of the two individual wheels facing away from the outer gear teeth. The bonded ring 18 is bonded to the inner surfaces on both sides. In this case, the bonded ring 18 extends over the entire double wheel. The ring 18 extends from the outer edge of the inner surface of one single wheel facing away from the contact surface between the two single wheels to the outer edge of the inner surface of the remaining single wheel.

The wheels can then be axially connected and secured with a bonded ring 18. The structure of this connection of two individual wheels is shown in FIG. 6. Here, too, the adhesive layer on the contact surface between ring 18 and the inner surfaces of the two individual wheels compensates for inaccuracies arising during manufacture and heat treatment.

The holes for the pins 12 as well as the annular groove for the ring 17 in the double wheel can thus preferably be produced less precisely, since the inaccuracies resulting from the manufacturing or heat treatment are eliminated by a small adhesive layer in the contact surfaces.

In this way, the necessary accuracy of the gearbox can be achieved. This largely avoids motion losses and angular transmission errors while keeping production costs low. In addition, damage to or destruction of the gear unit due to loose wheel coupling elements is avoided.

It is important to emphasize that both the rings 17, 18 can be combined with each other as connecting means and only one or both rings 17, 18 can be combined with the pin connections 12.

In addition to the connecting means, the two individual wheels can be bonded directly to each other to form the double wheel.

One or both external gears zs1, zs2 advantageously comprise a cycloidal gear. Accordingly, the first external gear zs1 and/or the second external gear zs2 can comprise a cycloid gear.

Preferably, the transmission designed as a cycloidal transmission 100 has cycloidal gear at least for the first external gear zs1 and for the second external gear zs2.

This means that the teeth of the internal splines z1, z2 can be designed with needle rollers 6 in a particularly simple manner, as described above.

Weights 15 can be arranged on the central shaft 9 of the transmission, which is advantageously designed as a cycloidal transmission 100, for dynamic compensation of eccentrically rotating masses.

The gear unit 100 designed as a cycloidal gear unit can be manufactured in a particularly compact manner if it is designed with only one eccentric section 13, on which only one gear 11, for example composed of two individual gears connected non-rotatably to one another, is provided with a first gear rim with the first external gear zs1 and with a second gear rim with the second external gear zs2. Particularly in such an arrangement, eccentrically rotating masses are present, which are advantageously compensated in the light of a vibration-free running to be aimed at.

It is important to emphasize that the invention may be realized by a gear having cycloidal teeth:
with a body 1 and an inner ring 2, between which an axial separating ring 7 is arranged and
with a bearing 3 that rotatably connects the body 1 and the inner ring 2.
The internal teeth z1, z2 comprise needle rollers 6 and internal grooves for the needle rollers 6, which mesh with cycloidal external teeth of the wheel 11 designed as a double wheel.
The wheel 11 is located on an eccentric section 13 formed on the shaft 9, also known as the eccentric surface.
The shaft 9 is located at both ends of the bearings 8 in the covers 4 and 5.
The covers 4 and 5 are firmly connected to the body 1 and inner ring 2, respectively.

The gear is characterized, for example, by the fact that the diameters of the tip circles and the diameters of the root circles, sometimes also referred to as heel circles, of the two cycloidal gears on the wheel 11, which is designed as a double wheel, are the same. At the same time, the number of teeth is different.

One embodiment of the invention is, for example, in the form of a planetary gear with a central shaft 9 arranged at both ends. The shaft 9 comprises an eccentric surface with at least one bearing preferably designed as a rolling bearing, particularly preferably as a radial bearing 10. Thereon is located a wheel 11 composed of two non-rotatably interconnected individual wheels and therefore also referred to as a double satellite. Each of the individual wheels of the wheel 11 is provided with one of the two external gears zs1, zs2.

This embodiment of the gear is characterized by the fact that the diameters of the tip circles and the diameters of the root circles, sometimes called heel circles, of the gear teeth on both individual gears of the satellite are the same. At the same time, the number of teeth is different. The eccentrically rotating masses are dynamically balanced by means of weights 15 attached to the central shaft 9.

In particular, the invention may be realized by a gear with cycloidal teeth, comprising a body 1 and an inner ring 2, between which an axial separating ring 7 is arranged, a bearing 3 rotatably connecting the body 1 and the inner ring 2, the internal grooves comprising the needle rollers 6 engaging with cycloidal external teeth of the wheel 11, designed as a double wheel, located on an eccentric surface surrounded by the eccentric portion 13 and formed on the central shaft 9. In this case, the central shaft 9 is arranged at both ends of the bearings 8 in the covers 4 and 5, which are fixedly connected to the body 1 and the inner ring 2, respectively. The diameters of the tip circles and the diameters of the root circles, sometimes called heel circles, of the two cycloidal teeth on the wheel 11 are the same. The number of teeth, on the other hand, is different.

Advantageously, the invention can be realized by a transmission described above with cycloidal gear, in which the wheel 11 designed as a double wheel is formed by bonding two individual wheels. The individual wheels can be axially secured by bonded pin connections 12. Advantageously, the two individual wheels are connected to each other by bonded connecting means which are bonded to both the one and the other individual wheel.

The invention may furthermore be realized by a gear unit with cycloidal gear described above. In the gear, the needle rollers 6 arranged in the grooves of the body 1 and the inner ring 2 are secured axially and radially in the recesses of the covers 4 and 5.

The present invention aims to provide a precision gearbox with:
small dimensions, preferably with a diameter equal to or less than 80 mm,
a hollow shaft with a central through opening and
a wide range of transmission ratios.

The solution further described eliminates radial space constraints in cycloidal gears by not using transformation elements between the gears and the outlet flange. This enables cycloidal gear designs with small dimensions and with a central through hole. This meets the requirements for precision gears with small dimensions, low weight and a relatively large opening in the shaft. In addition, it is possible to achieve a much wider range and maximum value of transmission ratios with a relatively high load capacity and low manufacturing costs.

According to the invention, a gear suitable for precision gear designs is provided, for example, in the form of a cycloidal gear 100 or a planetary gear with a central shaft 9 arranged at both ends in bearings 8. The central shaft 9 extends along the cylinder axis 14 of a hollow-cylindrical base body 1. Furthermore, the transmission comprises a ring mounted rotatably about the cylinder axis 14 relative to the base body 1. The ring is designed, for example, as an inner ring 2. The inner ring 2 is mounted by means of a bearing 3 in the base body 1 so as to be rotatable about its cylinder axis.

A first set of internal teeth z1 is arranged on the inner circumference of the hollow cylindrical base body 1. A second set of internal teeth z2 is arranged on the inner circumference of the ring, which is designed as an inner ring 2, for example.

The central shaft 9 is mounted rotatably about the cylinder axis 14 both relative to the base body 1 and relative to the ring, which is designed, for example, as an inner ring 2. The central shaft 9 has an eccentric section 13. The eccentric section 13 comprises an eccentric bearing surface formed on the central shaft 9, on which at least one radial bearing 10 is arranged. A wheel 11 with a first cycloidal external gear zs1 and with a second cycloidal external gear zs2 is arranged on the radial bearing 10 as a satellite wheel. The wheel 11 meshes via the first cycloidal external gear zs1 with the first internal gear z1 on the inner circumference of the base body 1. The wheel 11 meshes via the second cycloidal external gear zs2 with the second internal gear z2 on the inner circumference of the ring designed, for example, as an inner ring 2. The wheel 11 is formed as a double wheel by connecting two individual wheels which are non-rotatably connected to each other in correspondence of their axes and are each provided with one of the two external gears zs1, zs2.

This gear is advantageously characterized by the fact that the diameters of the tip circles and the diameters of the root circles, sometimes also referred to as heel circles, of the external gears zs1, zs2 on the two individual gears of the gear 11 forming the satellite are the same. In this case, the number of teeth is different. In particular, this gear is also characterized by the fact that the two individual wheels are connected to each other by bonded connecting means. These are bonded to both the one individual wheel and the other individual wheel.

The external teeth zs1, zs2 of the wheel 11 forming the satellite mesh with the internal teeth z1, z2. The internal splines z1, z2 are preferably in the form of needle rollers 6. The internal splines z1, z2 are arranged in two parts that can rotate relative to one another—in the base body 1 and in the ring designed, for example, as an inner ring 2.

Due to the different number of teeth of the intermeshing gear pairs:
first external gear zs1 and first internal gear z1,
second external gear zs2 and second internal gear z2
   rotation of the central shaft 9 results in mutual angular rotation of the basic body 1 and the inner ring 2 according to a transmission ratio i of the kinematic arrangement. The mutual rotation of these two parts, comprising the base body 1 and the ring designed, for example, as an inner ring 2, is made possible by the bearing 3. Apart from the torque, the bearing 3 transmits all force and torque effects between the two parts. At the same time, the base body 1 and the inner ring 2 serve to support the central shaft 9 by directly or—via the covers 4, 5—indirectly accommodating the bearings 8, designed for example as rolling bearings 8, at their two ends. Furthermore, the base body 1 and the inner ring 2 serve to fasten the gear unit to the frame or to the driven element. The gear further comprises weights 15, which are attached to the central shaft 9 opposite the eccentric shaft surface in opposition to the eccentric section 13. The weights serve to dynamically balance the eccentrically rotating masses.

The kinematic diagram of the gear unit is shown in FIG. 1. It shows a basic body 1 with the first internal gear z1 with a number nz1 of its teeth and a ring designed as an inner ring 2 with the second internal gear z2 with a number nz2 of its teeth. The inner ring 2 is rotatably mounted in the base body 1. In the same way, it is possible for the ring to be rotatably mounted on the base body 1 about its cylinder axis 14, for example, in axial extension of the base body 1. Furthermore, in FIG. 1 the central shaft 9 is rotatably mounted at its two ends in the base body 1 and in the inner ring 2. On the central shaft 9 there is an eccentric section 13, on which the wheel 11, designed as a double satellite consisting of two individual wheels non-rotatably connected to each other, is rotatably mounted. Each of the two individual wheels, which are non-rotatably connected to each other in accordance with their axes, is provided with one of the two external gears zs1, zs2.

The first external gear zs1 of the wheel 11 forming the satellite with a number nzs1 of its teeth engages in the first internal gear z1 on the inner circumference of the base body 1. The second external gear zs2 with a number nzs2 of its teeth engages the second internal gear z2 on the inner circumference of the ring designed as an inner ring 2. In such a kinematic arrangement, the transmission ratio is

i=1/(1−(nzs2/nz2)*(nz1/nzs1)).

If the value of i is positive, the directions of rotation of the central shaft 9 and the ring designed, for example, as an inner ring 2 are the same. If the value of i is negative, the directions of rotation of the central shaft 9 and the ring designed as an inner ring 2, for example, are opposite.

Embodiments of a transmission designed as a cycloidal transmission 100 are further described with reference to FIG. 2, FIG. 3, FIG. 4, FIG. 5, FIG. 6 and FIG. 7.

The gear unit is shown in FIG. 2 in a longitudinal section and in FIG. 7 in one of the axonometric views. The transmission consists of a base body 1 and an inner ring 2, which are rotatably connected to each other via a bearing 3. The bearing 3 is characterized in that it transmits all force and torque effects between the base body 1 and the inner ring 2, except for the torque. Each of the mentioned parts, the base body 1 and the inner ring 2, has openings by means of which they can be fixed to a frame or to a driven element. The transmission further comprises a cover 4, referred to as the inlet cover for better distinction, and a cover 5, referred to as the outlet cover, which may have a similar or identical shape. The cover 4 is attached to the base body 1 by means of screws, and the cover 5 is attached to the inner ring 2. The base body 1 and the inner ring 2 comprise grooves in which needle rollers 6 are mounted, which form the first internal gear z1 on the base body 1 and the second internal gear z2 on the inner ring 2. To prevent mutual interaction between the needle rollers 6 of the different internal gears z1, z2, they are separated by an axial separating ring 7. The separating ring 7 is inserted between the base body 1 and the inner ring 2. The needle rollers 6 can be secured axially and radially in recesses in the covers 4 and 5. The covers 4 and 5 preferably comprise running surfaces for the rolling bearing elements of the bearings 8, in which the central shaft 9 is arranged at its two ends. At least one running surface is formed on the eccentric section 13 of the central shaft 9, on which radial bearings are located. A wheel 11 designed as a double satellite wheel is arranged on the radial bearings 10. The wheel 11 is formed by connecting two individual wheels, each with cycloidal external teeth. Thereby, a first individual wheel of the wheel 11 is provided with the first external gear zs1. A second individual wheel of the wheel 11 is provided with the second external gear zs2.

The two individual wheels are connected to each other by bonded lanyards. The bonded lanyards are bonded to one single wheel as well as to the other single wheel.

The gear is preferably characterized by the fact that the diameters of the tip circles and the diameters of the root circles, sometimes called heel circles, of the gear teeth on both gears are the same. At the same time, the number of teeth is different.

Weights 15 are arranged on the shaft 9, which serve to dynamically balance the eccentrically rotating masses. Pins 16 serve to fix the weights 15 in a rotational position relative to the eccentric shaft surface against the eccentric section 13 on the central shaft 9.

The transmission may alternatively or additionally have individual or a combination of several features mentioned in connection with the prior art and/or in one or more of the documents mentioned with respect to the prior art and/or in the preceding description or in the claims still to follow.

The invention is not limited by the description based on the embodiments. Rather, the invention encompasses any new feature as well as any combination of features. In particular, this includes any combination of features in the claims, even if that feature or combination itself is not explicitly stated in the claims or embodiments.

The invention is commercially applicable, for example, in the field of automation technology, especially in robot technology and in the field of mechanical engineering.

The invention has been described with reference to a preferred embodiment. However, it is conceivable to one skilled in the art that variations or modifications of the invention may be made without departing from the scope of protection of the claims below.

### LIST OF REFERENCE SIGNS

1 Base body
2 Inner ring
3 Bearing
4 Cover (base body)
5 Lid (ring)
6 Needle roller
7 Separator ring
8 Bearing
9 Central shaft
10 Radial bearing
11 Wheel
12 Pin connection
13 eccentric section
14 Cylinder axis
15 Weight
16 Pin
17 Ring
18 Ring
z1 first internal gear
z2 second internal gear
zs1 first external gear
zs2 second external spline
100 Cycloidal gearbox

1. Transmission (100), comprising:
a hollow cylindrical base body (1) with a first internal gear (z1),
a ring (2) arranged rotatably about the cylinder axis (14) of the base body (1) and having a second internal gear (z2),
a central shaft (9) extending along and rotatable about the cylinder axis (14) and having an eccentric portion (13), and
a wheel (11) rotatably mounted on the eccentric portion (13) and having a first external gear (zs1) via which it meshes with the first internal gear (z1) of the base body (1) and a second external gear (zs2) via which it meshes with the second internal gear (z2) of the hollow cylindrical ring,
characterized in that
in that the wheel (11) is designed as a double wheel comprising two individual wheels which are non-rotatably connected to one another in correspondence of their axes and are each provided with one of the two external gears (zs1, zs2) and are connected to one another by bonded connecting means which are bonded both to one and to the other individual wheel.

2. Transmission according to claim 1,
characterized in that
that the connecting means comprise bonded pin connections (12) by which the two individual wheels are axially secured.

3. Gearbox according to claim 1,
characterized in that
in that the bonded pin connections (12) extend through axial through-holes in one of the two individual wheels into axial blind holes in the remaining individual wheel of the two individual wheels.

4. Gearbox according to claim 1,
characterized in that
in that the bonded pin connections (12) are arranged in blind holes arranged opposite one another on the end faces of the individual wheels.

5. Gearbox according to claim 1,
characterized in that
that the connecting means comprise at least one bonded ring (17, 18) by which the two individual wheels are axially secured.

6. Gearbox according to claim 1,
characterized in that
in that the ring (17) is glued into grooves arranged opposite each other on the faces of the individual wheels.

7. Gearbox according to claim 1,
characterized in that
that the ring (18) is glued to the inner circumference of the individual wheels.

8. Gearbox according to claim 1,
characterized in that
in that the diameters of the tip circles and the diameters of the root circles of the two external gears (zs1, zs2) on the wheel (11) are the same, the number of teeth being different.

9. Gearbox according to claim 1,
characterized in that
that the central shaft (9) is hollow.

10. Gearbox according to claim 1,
characterized in that
that the ring is designed as an inner ring (2) rotatably mounted in the base body (1).

11. Gearbox according to claim 1,
characterized in that
in that an axial separating ring (7) is arranged between the ring (2) and the base body (1).

12. Gearbox according to claim 1,
characterized in that
in that one or both internal gears (z1, z2) comprise needle rollers (6).

13. Gearbox according to claim 1,
characterized in that
that a cover (4) is non-rotatably connected to the base body (1), on or in which cover (4) the central shaft (9) is rotatably mounted.

14. Gearbox according to claim 1,
characterized in that
that a cover (5) is non-rotatably connected to the ring, on or in which cover (5) the central shaft (9) is rotatably mounted.

15. Gearbox according to claim 1,
characterized in that
in that one or both external gears (zs1, zs2) comprise cycloidal gear.

16. Gearbox according to claim 1,
characterized in that
in that weights (15) are arranged on the central shaft (9) for dynamic compensation of eccentrically rotating masses.

17. Gearbox according to claim 1,
characterized in that
that the needle rollers (6) arranged in the grooves of the body (1) and the ring (2) are axially and radially secured by means of recesses formed in the covers (4) and (5).
